(19) United States
(12) Patent Application Publication
(10) Pub. No.: US 2003/0156429 A1
(43) Pub. Date: Aug. 21, 2003

(54) Hair ornament having a plurality of optic fibers and three primary color light-emitting diodes

(76) Inventor: Joel MacDonald, Salt Lake City, UT (US)

Correspondence Address: Angus C. Fox, III, 4093 N. Imperial Way, Provo, UT, 84604-5386, US

(21) Appl. No.: 10/369,243

(22) Filed: Feb. 18, 2003

Related U.S. Application Data
(60) Provisional application No. 60/357,337, filed on Feb. 15, 2002.

(51) Int. Cl. F21L 4/02; F21V 21/088

(52) U.S. Cl. 362/570; 362/565; 362/103

(57) ABSTRACT

A hair ornament includes multiple light-emitting diodes (LEDs) which are manufactured as a single component so that their combined output can be focused on the end of a bundle of optic fibers. The fibers may be woven in the hair or wig of a wearer of the ornament. For a preferred embodiment of the invention, three LEDs, each of which emits a primary color (generally red, green or blue), are provided. Each LED is coupled to a flasher circuit having both variable frequency and variable duty cycle. At low frequencies (i.e., less than about 18-20 flashes per second), the flashes are seen as discrete colors. However, as the frequencies are increased, only a single color is visible. The color of that single color can be varied over the visible spectrum by varying the duty cycles of the three LEDs. One use of the preferred embodiment is to adjust the projected color to coordinate with clothing of the user.

This application has a priority date of Feb. 15, 2002, as evidenced by the filing on that date of a Provisional Patent Application Ser. No. 60/357,337 titled FIBEROPTIC LIGHT SOURCE DESIGN FOR HAIR.

### BACKGROUND OF THE INVENTION

1. Field of the Invention

This invention relates to decorative wearing apparel and, more particularly, to decorative ornaments, securable in a woman's coiffeur, which utilize a light source and optic fibers to provide a decorative effect thereto.

2. Description of the Prior Art

Hair ornaments and decorations of many types have been used for thousands of years. Such decorations may be temporarily held in place by hair barrettes, clips, combs, or a variety of like devices. Hair ornaments incorporating battery-powered illumination began to appear in the late 1960s. For example, U.S. Pat. No. 3,501,628 to W. A. Madden discloses an illuminated hair ornament having a plurality of miniature electric lamps attached to a comb-supported battery with thin wires that may be concealed within the coiffure. Later patents employed a battery, a single light source and optic fibers to transmit the light to positions in the coiffure remote from the light source and battery.

The earliest example of a optic fiber hair ornament is likely disclosed in U.S. Pat. No. 3,675,005 to Raymond F. Curiel. The Curiel apparatus includes a tubular member having a battery and a lamp secured therein. A plurality of optic fibers, which are clamped and mounted adjacent the lamp, transmit the light to selected locations in the coiffure. A removable lens is positioned between the lamp and the clamped ends of the fibers to permit changing the color of the transmitted light. The tubular member is enclosed within a flexible mesh to facilitate securing it to the coiffure. A similar apparatus designed primarily for wigs is described in U.S. Pat. No. 3,758,771 to Esther and Melvin Frohardt.

U.S. Pat. No. 4,998,186 to Lorraine Cocca discloses a decorative hair ornament having a plurality of optic fibers attached to a barrette or hair clip. The optic fibers are extended outwardly from a diode light source powered by an onboard battery. Decorations such as gemstones, artificial flowers, and the like are provided to conceal the diode light source and battery. A similar device is disclosed in Japanese Pat. No. 2000070028A to Ogawa Hidekazu.

U.S. Pat. Nos. 4,998,186; 3,758,771 and 3,675,005 are incorporated herein by reference in order to show the manner in which the optic fibers are woven into the user's hair or wig.

Finally, U.S. Pat. Nos. 5,573,017 and 5,727,577 to James M. Post disclose an optical ornament which can be attached to the hair, clothing or body or to another object. The ornament includes a plurality of optic fibers which retransmit light and redistribute light received by a lens or reflector adjacent the transmitting ends of the optic fibers.

Each of the prior art hair ornament devices described above may be characterized as generally having a fixed color of illumination. Only the Curiel device contemplates the placement of lenses of different colors over the light source in order to change the color of the transmitted light. However, the number of possible colors is limited to the number of available colored lenses.

What is needed is a lighted hair ornament having greater flexibility with regard both to the number of colors which may be transmitted through the optic fibers and the availability of other special lighting effects.

### SUMMARY OF THE INVENTION

The present invention expands the flexibility and usefulness of lighted hair ornaments. The preferred embodiment of the improved hair ornament includes a generally cylindrical body housing a single N-size 1.5-volt cell, three light-emitting diodes (LEDs) having a common ground electrode packaged as a single component with a single focusing lens, a bundle of optic fibers having one end thereof positioned adjacent the focusing lens so that the light from the LED component is transmitted into the fibers, and a pulse-width-modulated (PWM) flasher circuit. The flasher circuits are controlled by a microcontroller having various programmed modes which can be selected by the user. The various modes are constantly changing color, blinking random changing colors, fixed adjustable color and blinking white light. In the final mode, pulse frequency is modified so that all three LEDs are on and off simultaneously, with no pulse-width modulation required during the “on” portion of the cycle. When the an LED flashes at more than about 18 times a second, the LED appears to a human observer to be “on” continuously. Thus, when the flashing frequency of each LED is greater than 18, and the light emitted from the three LEDs combines so as to be perceived by a viewer as a single color, the single color being a combination of the duty cycles of the three LEDs. The single perceived color can be varied over the visible spectrum by varying the duty cycle of each of the three LEDs independently of the others. One use of the preferred embodiment is to adjust the projected color to coordinate with clothing of the user. This may be accomplished by setting the duty cycle of each LED to achieve the desired color mix. For the preferred embodiment of the invention, mode selection and selection of a particular color is accomplished by sequentially pressing a single control button.

An alternative embodiment of the invention includes a separate ON/OFF switch, a separate DIP-switch for selecting an operational mode, and individual variable resistors which are used to individually adjust the PWM duty cycle for each of the three LEDs. The cylindrical body is preferably affixed to a spring-loaded clip, with which the ornament may be securely fastened to the hair or wig of a user. With the ornament secured, the individual optic fibers may be woven in the hair or wig of the wearer.

The optic fibers of any of the aforedescribed embodiments may be dyed or painted with a flexible paint on their outer surfaces in order to camouflage them while being worn in the hair, and to prevent the bleed-out of the transmitted light. As hair color varies markedly between different individuals, the optic fibers would necessarily need to be dyed to match a particular hair color.

### BRIEF DESCRIPTION OF THE DRAWINGS

FIG. 1 is a cut-away view of a new first embodiment lighted hair ornament;

FIG. 2 is a side elevational view of the new first embodiment lighted hair ornament;

FIG. 3 is a cut-away view of a new second embodiment lighted hair ornament;

FIG. 4 is a side elevational view of the new second embodiment lighted hair ornament;

FIG. 5 is a block diagram of a common prior art circuit that may be used to drive three light emitting diodes combined in a single component;

FIG. 6 is a perspective exploded view of a claw-type hair clip and a second embodiment lighted hair ornament; and

FIG. 7 is a cross-sectional view through an optic fiber that has been dyed or painted on its outer surface.

### DETAILED DESCRIPTION OF THE INVENTION

The improved lighted hair ornament will now be described with reference to the included drawings. It should be understood that the drawings are not necessarily drawn to scale, are intended to be merely illustrative of the invention, and should therefore not be construed as unnecessarily limiting the invention.

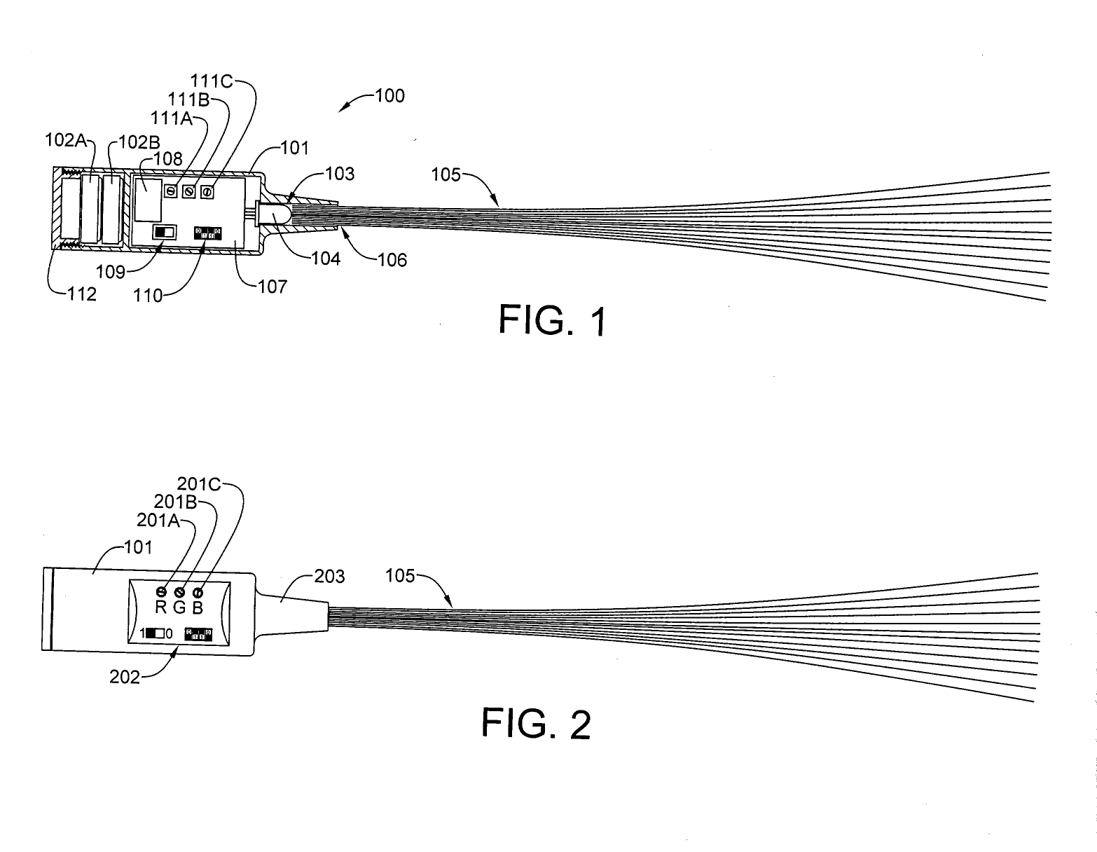

Referring now to cut-away view of FIG. 1, a first embodiment improved optic fiber lighted hair ornament 100 includes a generally cylindrical body 101 housing a pair of button 1.5-volt cells 102A and 102B, three light-emitting diodes (LEDs) having a common ground electrode packaged as a single component 103 with a single diffusing lens 104, a optic fiber bundle 105 having one end 106 thereof positioned adjacent the diffusing lens so that the light from the LED component 103 is transmitted into the individual fibers of optic fiber bundle 105. The first embodiment hair ornament 100 also includes a printed circuit board 107 having a pulse-width-modulated (PWM) flasher circuit 108 and user accessible controls which include an ON/OFF switch 109, a DIP-switch 110 for selecting an operational mode, and individual variable resistors 111A, 111 B and 111 C, which are used to individually adjust the PWM duty cycle for each of the three LEDs in single component 103. Selection of the individual duty cycles controls the color perceived by a human observer. The various modes selectable with the dip switch include constantly changing color, blinking random changing colors, fixed adjustable color and blinking white light. A screw-on cap 112 retains the two 1.5 V cells.

Referring now to FIG. 2, a first embodiment improved optic fiber lighted hair ornament 100 is shown with the cylindrical body 101 intact. The ON/OFF switch 109, DIP-switch 110, and slotted adjusters 201A, 201B and 201C of individual variable 111A, 111 B and 111C, respectively, are all accessible by the user, and reside in a depression 202 in the side of the cylindrical body 101. Nosepiece 203 is crimped to retain the optic fiber bundle 105.

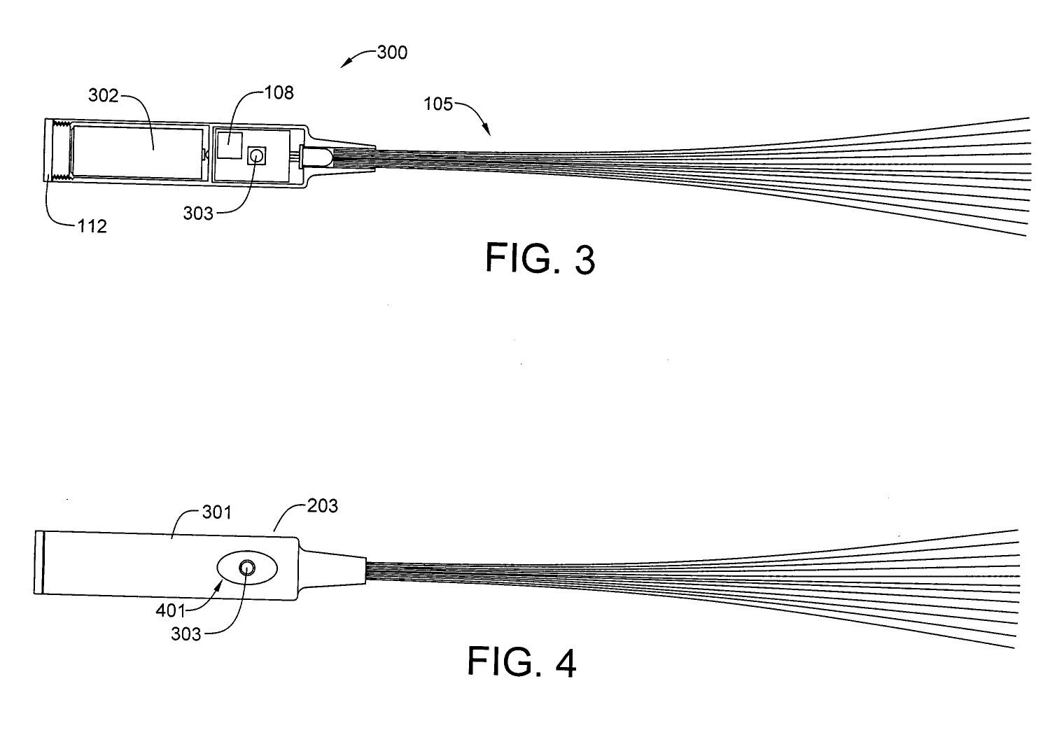

Referring now to FIG. 3, a second, and generally preferred, embodiment improved optic fiber lighted hair ornament 300 includes a generally cylindrical body 301 housing a single N-type 1.5-volt cell 302, three light-emitting diodes (LEDs) having a common ground electrode packaged as a single component 103 with a single diffusing lens 104, a optic fiber bundle 105 having one end 106 thereof positioned adjacent the diffusing lens so that the light from the LED component 103 is transmitted into the individual fibers of optic fiber bundle 105. For this preferred embodiment of the invention, ON/OFF, mode selection and selection of a particular color is accomplished by sequentially pressing a single control button 303.

Referring now to FIG. 4, a second embodiment improved optic fiber lighted hair ornament 300 is shown with the cylindrical body 301 intact. Only the single control button 303, which resides in a depression 401 in the side of the cylindrical body 301, is externally accessible by a user.

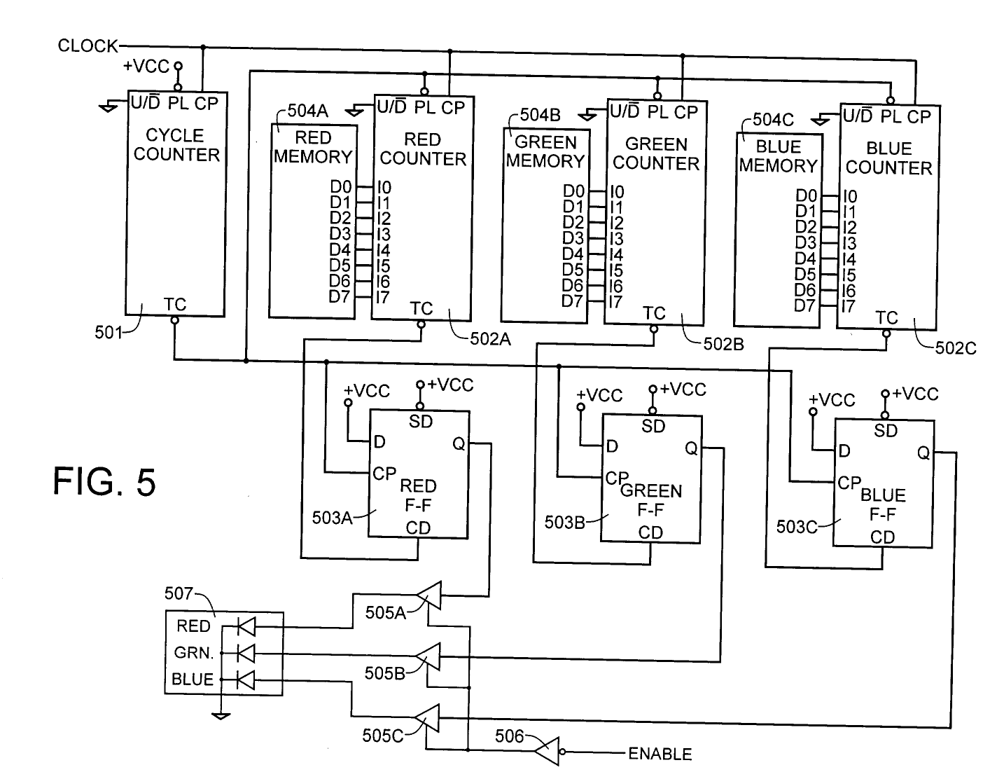

Referring now to FIG. 5, a prior art circuit, shown as a block diagram and modified for the present invention, may be used to drive three light emitting diodes combined in a single component in a continuously variable format. The basic circuit is found in U.S. Pat. No. 4,845,481, which issued to Karel Havel on Jul. 4, 1989. This patent is incorporated by reference in the present application. The circuit implements pulse-width modulation (PWM) using a circuit module for each color, which includes a memory, a counter, and a flip-flop in combination with a shared cycle counter 401. Thus, red memory 404A, red counter 402A and red flip-flop 403A are associated with the production of pulse-width modulated red light; green memory 404B, green counter 402B and green flip-flop 403B are associated with the production of pulse-width modulated green light; and blue memory 404C blue counter 402C and blue flip-flop 403Care associated with the production of pulse-width modulated blue light. The cycle counter 401 and each counter (402A, 402B and 402C) are controlled by a common clock signal CLOCK. Pulse-width-modulated activation signals from the flip-flops are sent to drivers 405A, 405B and 405C, each of which controls a red, green and blue LED of single component tri-LED 407. The duty cycle of each LED is a function of the quantity of data loaded into the counters. If each memory is programmed with different quantities of data, the color output by the single component tri-LED 407 will be constantly variable.

A more modern technique for creating different color effects using LEDs is found at the British website with the following URL: http://www.emanator.demon.co.uk. This technique, in use by the author since about 1992, also employs a three channel approach (one channel for each primary color). However, the author utilizes a microcontroller (specifically, a PIC12C508A microcontroller) in combination with an octal darlington driver (part number ULN2803). The software has been written for a single effect: each channel is ramped upward from their lowest setting to their highest before gently ramping each color up and down independently between a series of pre-programmed intensities which are different for each color. Since each color takes a different time to work its way through its set of intensity values before looping, the overall effect is a completely random constantly changing color output. This approach is also employed by U.S. Pat. No. 6,016,038, which issued to George G. Mueller, et al. On Jan. 18, 2000. This patent is hereby incorporated by reference in this application. The intensity of each of three primary color LEDs is determined by data packets sent to the microprocessor. Each data packet contains a an intensity value byte that corresponds to a decimal number 1 to 255, linearly representing the desired intensity from full off to full on. These respective intensity values are stored in respective color registers within the memory of the microcontroller. The microcontroller runs a routine designed to create a square wave signal on outputs for each primary color. The values in the color registers determine the duty cycle of the square wave.

A light wand bearing the trademark “SAUCE” claims to use the invention of U.S. Pat. No. 6,016,038. A complete description of this light wand can be found at the website having the following URL: http://www.cksauce.com. The light wand has five modes operable by sequentially pressing a single control button: 1) color wash; 2) random color; 3) fixed color; 4) strobe; and 5) off. The applicant has purchased one such light wand and has disassembled it. It appears that the light wand incorporates the following principal components: a read-only memory (ROM), a microcontroller and an octal darlington driver. By sequentially pressing the control button, the mircocontroller accesses different lighting effects programs permanently stored in the ROM. In accordance with the various programs, the microcontroller accesses data packets also stored in the ROM to provide the various lighting effects.

In any case, the technology necessary to provide the various desired lighting effects in the present invention is readily available in the art.

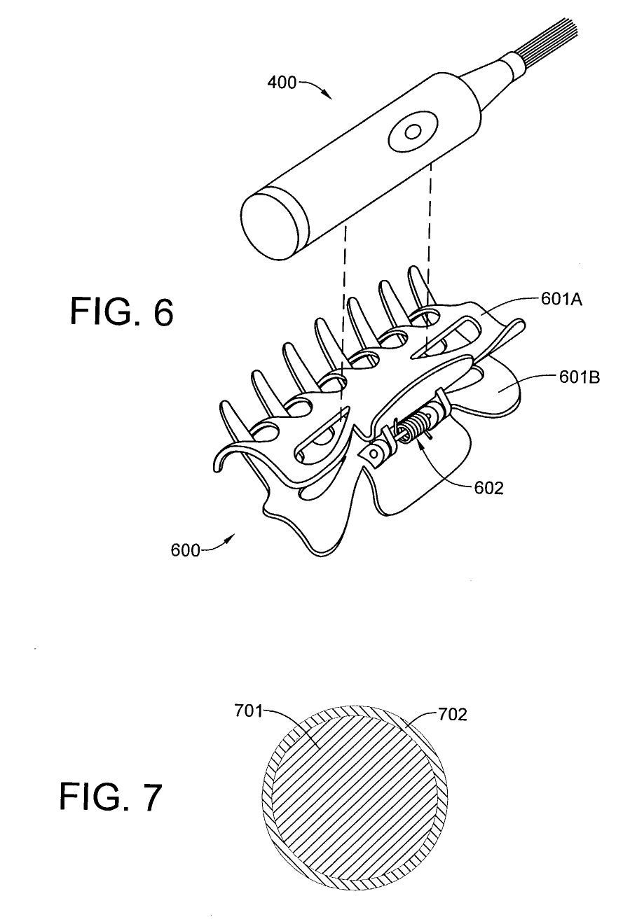

Referring now to FIG. 6, a second embodiment improved optic fiber lighted hair ornament 30 is shown positioned above a claw-type hair clip, to which the ornament 300 may be attached with screws, double-stick tape, or adhesive along, and with which the ornament 300 may be attached to the hair or wig of a user.

Referring now to FIG. 7, the optic fibers of any of the aforedescribed embodiments may be dyed or painted with a flexible paint on their outer surfaces in order to camouflage them while being worn in the hair, and to prevent the bleed-out of the transmitted light. FIG. 7 shows an optic fiber 701 having a coating 702 thereon. The coating may be a flexible latex paint selected to match the color of the user's hair. Alternatively, the fiber 701 may be dyed to match the color of the user's hair. In such a case, the region 702 would be a darkened portion of the fiber itself, with the dye molecules having been absorbed into the body of the fiber 701.

Although only several embodiments of the invention have been disclosed herein, it will be obvious to those having ordinary skill in the art that changes and modifications may be made thereto without departing from the spirit and scope of the invention as hereinafter claimed.

What is claimed is:

1. A decorative hair ornament comprising:
a housing;
a battery installed within said housing for discharging electric current on demand;
at least two light-emitting diodes (LEDs) secured to said housing, each of which produces a different color output when energized with electric current from said battery;
a diffuser lens which combines the light output from said LEDs;
a plurality of optic fibers bundled together at one end, the bundled end of said optic fibers being secured to said housing, and positioned so that the combined light output is incident thereon, thereby transmitting light from each of the LEDs into the bundled ends of substantially all of the optic fibers;
control circuitry installed within said housing and powerable by current from said battery that provides flashing capability and duty cycle variability of to each of the LEDs.

2. The decorative hair ornament of claim 1, wherein the duty cycles of each of the LEDs is varied automatically to continually vary the perceived color of the common beam.

3. The decorative hair ornament of claim 1, wherein all the LEDs are fabricated as a single component having a common negative electrode.

4. The decorative hair ornament of claim 3, wherein said single component also integrates said diffuser lens.

5. The decorative hair ornament of claim 1, wherein three LEDs are provided, each of which produces light of a primary color.

6. The decorative hair ornament of claim 5, wherein the primary colors produced are red, green and blue.

7. The decorative hair ornament of claim 1, wherein said control circuitry is adjustable by the user to vary the flash rate of the LEDs.

8. The decorative hair ornament of claim 1, wherein said control circuitry is adjustable by the user to set the duty cycle of each LED to a desired level.

9. A decorative hair ornament comprising:
a housing;
a battery installed within said housing for discharging electric current on demand;
at least two, and no more than three, light-emitting diodes (LEDs) fabricated as a single component which incorporates a single diffuser lens which combines the light output from said LEDs, each LED producing a different color output when energized with electric current from said battery, said single component being secured to said housing;
a plurality of optic fibers bundled together at one end, the bundled end of said optic fibers being secured to said housing, and positioned so that the combined light output is incident thereon, thereby transmitting light from each of the LEDs into the bundled ends of substantially all of the optic fibers;
control circuitry installed within said housing and powerable by current from said battery that provides flashing capability and duty cycle variability of to each of the LEDs.

10. The decorative hair ornament of claim 9, wherein each of the LEDs have a ground electrode in common with the other LEDs.

11. The decorative hair ornament of claim 9, wherein the duty cycles of each of the LEDs is varied automatically to continually vary the perceived color of the common beam.

12. The decorative hair ornament of claim 9, wherein each of the LEDs produces light of a primary color.

13. The decorative hair ornament of claim 12, wherein the single component contains three LEDs, and the primary colors produced are red, green and blue.

14. The decorative hair ornament of claim 9, wherein said control circuitry is adjustable by the user to set the flash rate of the LEDs.

15. The decorative hair ornament of claim 9, wherein said control circuitry is adjustable by the user to set the duty cycle of each LED independently of the others.

16. A decorative hair ornament comprising:
a housing;
a battery installed within said housing for discharging electric current on demand;
three light-emitting diodes (LEDs) fabricated as a single component which incorporates a single diffuser lens which combines the light output from said LEDs into a generally cylindrical common beam, said three LEDs sharing a common negative electrode, each LED producing a different primary color light output when energized with electric current from said battery, said single component being secured to said housing;
a plurality of optic fibers bundled together at one end, the bundled end of said optic fibers being secured to said housing, and positioned so that the combined light output is incident thereon, thereby transmitting light from each of the LEDs into the bundled ends of substantially all of the optic fibers;
control circuitry installed within said housing and powerable by current from said battery that provides flashing capability and duty cycle variability of to each of the LEDs.

17. The decorative hair ornament of claim 16, wherein the duty cycles of each of the LEDs is varied automatically to continually vary the perceived color of the common beam.

18. The decorative hair ornament of claim 16, which further comprises a claw-type hair clip attached to said body.

19. The decorative hair ornament of claim 16, wherein the outer surface of each of the optic fibers is coated to prevent the bleed-out of transmitted light.

20. The decorative hair ornament of claim 16, wherein said control circuitry is adjustable by the user to set the duty cycle of each LED.
